(19) United States
(12) Patent Application Publication
(10) Pub. No.: US 2006/0168143 A1
(43) Pub. Date: Jul. 27, 2006

(54) Automated method for executing a service order directed to a particular beneficiary, initiated after query requiring minimal response

(76) Inventor: John Moetteli, Untereggen (CH)

Correspondence Address: MOETTELI & ASSOCIATES SARL, ST. LEONHARDSTRASSE 4, ST. GALLEN, CH-9000, CH

(21) Appl. No.: 11/335,546

(22) Filed: Jan. 20, 2006

Related U.S. Application Data
(60) Provisional application No. 60/645,616, filed on Jan. 24, 2005.
(60) Provisional application No. 60/675,906, filed on Apr. 29, 2005.
(60) Provisional application No. 60/721,981, filed on Sep. 30, 2005.

(51) Int. Cl. G06F 15/16

(52) U.S. Cl. 709/219

(57) ABSTRACT

An automated method is provided, operating on a computer and encoded on a computer-readable medium, for executing a logic flow that executes a service order on behalf of a client upon certain pre-scribed conditions. The service order is organized by the client according to the characteristics of each of at least one class of beneficiary. Permission for initiation of such service order is considered as having been granted upon, for instance, non-response by the client to a query offering the opportunity of modification of such order. The invention further enables the setup, maintenance and modification of dynamic memorial pages whose messages change based on the identification of the visitor. Such pages are customizable by the user to show an epitaph specific to the visitor and display or mask information depending on the class and/or permissions of the visitor.

### CROSS-REFERENCE TO RELATES APPLICATIONS

This application is a regular application claiming priority to prior provisional applications Ser No. 60/645,616, filed Jan. 24, 2005, Ser. No. 60/675,906, filed Apr. 29, 2005 of the same title, and Ser. No. 60/721,981, filed Sep. 30, 2005, entitled “SYSTEM AND METHOD FOR IMPLEMENTING DYNAMIC MEMORIAL WEBPAGES”, the contents of all of which are hereby incorporated by reference and relied upon.

### BACKGROUND OF THE INVENTION

This invention relates to communications and distribution systems and methods, and more particularly, to periodic, automated distribution systems for communicating emails, post, and/or packages to specific beneficiary/recipients.

Epitaphs have existed since time immemorial. Carved in stone or on wood, such epitaphs are a single message meant for everyone to read with no specificity as to content. Online memorials provide an editable means to convey a message. However, the content of such messages is static and does not change until changed by the administrator of the page. This static aspect discourages revisits to the page and thus increases the likelihood that the system will lose contact with the visitor due to the fact that the visitor is not going to receive reminders to keep their email address up to date.

Human relationships with a departed individual or a memorial object vary. Immediate family may warrant an epitaph which is more personal—for friends, a message more general. However, no means exists to communicate an epitaph message which is targeted to the visitor or to the season of the year, holiday theme, or to the particular day of the year.

Still further, a distressing part of death is the fact that it is a state of inanimation. Adding animation to death can help people cope with it, offering hope.

Still further, a fear that one facing death deals with is his legacy: “will I be forgotten?” The “Golden Rule” mandates that someone who wishes to be remembered must remember those he or she wants to remember him.

Existing mail programs permit a user to prepare a holiday, birthday, or other occasion card or email and send it at a prescribed time. Sites offering such service include http://www.TheCardShop4U.com and http://www.juststayintouch.com/. However, neither service organizes mailings by beneficiary/recipient. In the case of TheCardShop4U, you can write a series of cards for delivery at designated times, to any number of individual beneficiary/recipients. One pays on the spot for each order and the order is fulfilled at the designated time. Cancellation is possible only by logging on to the system and deleting the mailing orders individually. With JustStayinTouch, you provide your list of clients already selected for a particular service, be it an annual holiday mailing, or a quarterly mailing. An invoice, which must be paid by the sender, is sent periodically, along with a list of clients and the programs to which each client belongs (thus such systems are program specific, not specific to a particular beneficiary/recipient). No beneficiary/recipient-specific facility is provided by which one can organize mailing service orders and thus, such services are only adapted to treating broad classes of beneficiary/recipients on a periodic basis.

It may be known that one, anticipating death, sends out a death announcement which was prepared prior to death, after death, by asking someone to deposit prepared cards in an mailbox after the event of death. It may even be known to ask someone to send a periodic mailing to a particular recipient. Even so, the execution of the service order requires that a third party intervene and execute the order after having learned of the death of the client. Such systems require, therefore, that the client make an arrangement with an individual for execution of the service order prior to death and that the person be informed of the death of the individual, prior to execution of the service order. Further, copyright in any writings left behind for time released delivery belongs to the heirs of the deceased. Consequently, such service orders are subject to cancellation by the heirs or the confiscation of the letters which were intended to be delivered at a later date, in a periodic fashion.

Although many users may be willing to prepare and order a card or gift to be sent in advance, the possibility remains that something may happen to the recipient or the relationship between the recipient and the sender, which would warrant editing, changing, or cancelling the prior-ordered service order. However, the individuals who order such actions in advance are very busy individuals who simply do not have time to think about the order anymore after it's been placed. The above systems fail to serve such individuals because such systems require a sometimes cumbersome login process on the part of the client sender, to modify or cancel the service order. Still further, such systems fail to provide a mechanism to better ensure that such cards and/or gifts are not sent until they are timely, namely, after the death of the client individual.

Still further, it goes without saying that a client that is deceased cannot, using traditional means, communicate with those he or she has left behind. This fact causes considerable stress and anxiety among those who are faced with imminent death. This may be because they feel helpless in general or, specifically, they may wish to communicate something to someone but dare not when that person is alive (the recipient may not be prepared to know the truth), they wish simply to continue contact with their loved ones, or they feel that they may be too soon forgotten by them.

Further, for those who believe that a life exists after death, and that, after death, they will be able to observe what their loved one's are doing here on Earth, there exist nonetheless no method of influencing events among those who have not yet died. Certainly, no method exists to enable a deceased individual to communicate with a loved one at a predetermined point in time.

Still further, a fear that one facing death deals with is his legacy: will he be forgotten? The “Golden Rule” mandates that someone who wishes to be remembered must remember those he or she wants to remember him.

A need therefore exists for a system and method which enables dynamic communications with a visitor or with respect to the time of the visit. Further, a need exists for a system and method that brings animation mimicking life to a memorial object.

A need therefore exists for mailing service organized and structured according to the individual characteristics of the beneficiary/recipient. Further, a need exists for a service that is initiated by inaction on the part of the client, such as by someone who is too busy to otherwise intervene, who is incapacitated or even dead, which system not being dependent upon the actions or inactions of third parties. A need exists therefore for a system and a method that permits deceased individuals to communicate with those they left behind. Still further, a need exists for a means by which someone who wishes to be remembered after death, can remember those who he wishes remember him. Still further, a need exists for dealing with legal questions (such as ownership of copyright in the work) raised by such a service in the event that the client is deceased.

### SUMMARY OF THE INVENTION

An automated method is provided, operating on a computer and encoded on a computer-readable medium, for executing a logic flow that executes a service order on behalf of a client upon certain pre-scribed conditions. The service order is organized by the client according to the characteristics of each of at least one class of beneficiary. Permission for initiation of such service order is considered as having been granted upon non-response by the client to a query offering modification (inclusive of cancellation) of the order.

The method involves the following steps. In a first step, a memorial page administrator is registered. The administrator may be the memorial object itself, but need not be. In a second step, the method provides administrators with means of configuring displayed information on the page, dependent on a variable, non-web-based trigger parameter (i.e. dependent on a criteria such as the season, holiday theme, time of day, day, event, or the visitor or visitor class). In a third step, the method detects the existence of the trigger parameter. In a fourth step, after detection, the method displays customized information associated with the trigger parameter to visitors to the memorial page that are permitted to view such information, such customized information optionally persisting for a validity period of time.

In a feature, invitations may be sent out to selected invitees soliciting visits to the memorial page on particular days such as special events (birthdays, anniversaries, etc).

In an embodiment, a periodic newsletter, for example, may be sent to selected invitees at predetermined times.

An object of the invention is to enable dynamic communication of a message targeted to a particular visitor or class of visitors.

Another object of the invention is to enable dynamic communication of a message depending on the time, the date or the season, such as Christmas or a birthday.

Another object of the invention is to enable a deceased user to trigger an invitation to his own memorial page without requiring a specific trigger request from the deceased user. In an An object of the invention is that it is ideally used by those individuals who wish not to positively re-confirm the acceptability of a mailing or service order, but wish that such order be executed unless a positive act requesting cancellation or modification is received.

Another object of the invention is to alleviate the stress and anxiety associated with death, by providing a means for a client anticipating death to arrange for continued communication with his or her loved ones.

Another object of the invention is to enable a client to communicate with loved ones from the time of his or her death up until approximately the time that his or her loved ones die, in order to bridge the communication gap until such loved ones meet again.

Another object of the invention is to provide a means for a client anticipating death to make arrangement that will help ensure that he or she will not be soon forgotten.

Another object of the invention is to provide means for a deceased individual, to communicate with a loved one at a predetermined point in time, so as to enable the deceased individual to observe the reaction of the loved upon upon reading the message.

In a feature of the invention, an activation submethod actives the method upon non-response of the client to a query or series of queries.

Such a system is advantageously used by a very busy client, or a client anticipating incapacitation, namely, those who are aging and anticipate serious nursing care, death, or inaccessibility to conventional communications mediums to pre-order a service order for delivery to a prescribed beneficiary and such delivered at pre-specified dates.

In another advantage, a method is provided to help deal with an age-old, as yet, unsolved problem, of providing peace of mind to those facing an inevitable and stressful event.

In another advantage, a method is provided by which someone who wishes to be remembered after death, can remember those who he wishes remember him.

### BRIEF DESCRIPTION OF THE DRAWINGS

FIG. 1A is a logic flow diagram of the method of the invention.

FIG. 1B is a schematic of the event flow of the method of the invention.

FIG. 2 is a schematic diagram of a typical system on which the method of the invention operates.

FIG. 3 is a logic flow diagram of the registration submethod of the method of the invention of FIGS. 1A and 1B

FIG. 4 is a logic flow diagram of the activation submethod of the method of the invention.

FIG. 5 is a logic flow diagram of the service order execution submethod of the method of the invention.

FIG. 6 is a flow diagram of a delivery submethod of the invention.

FIG. 7 is an address updating submethod of the method of the invention.

### DETAILED DESCRIPTION OF THE PREFERRED EMBODIMENT(S)

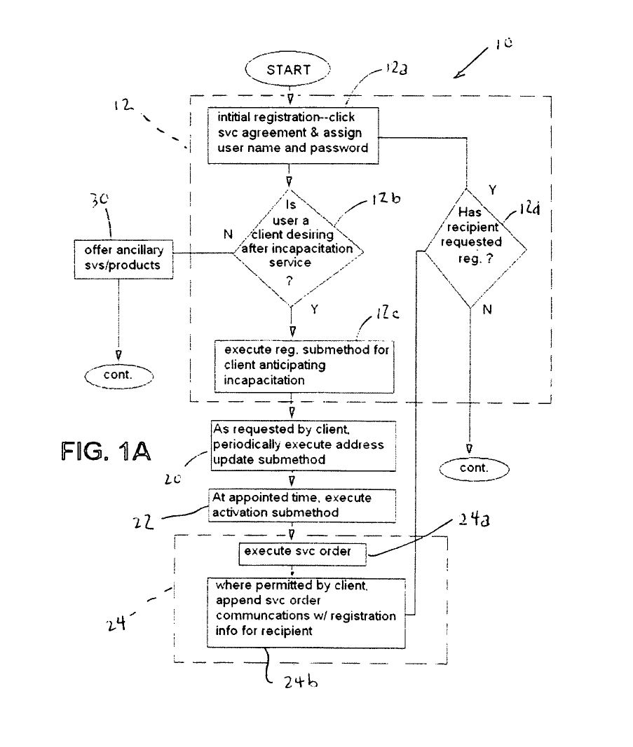

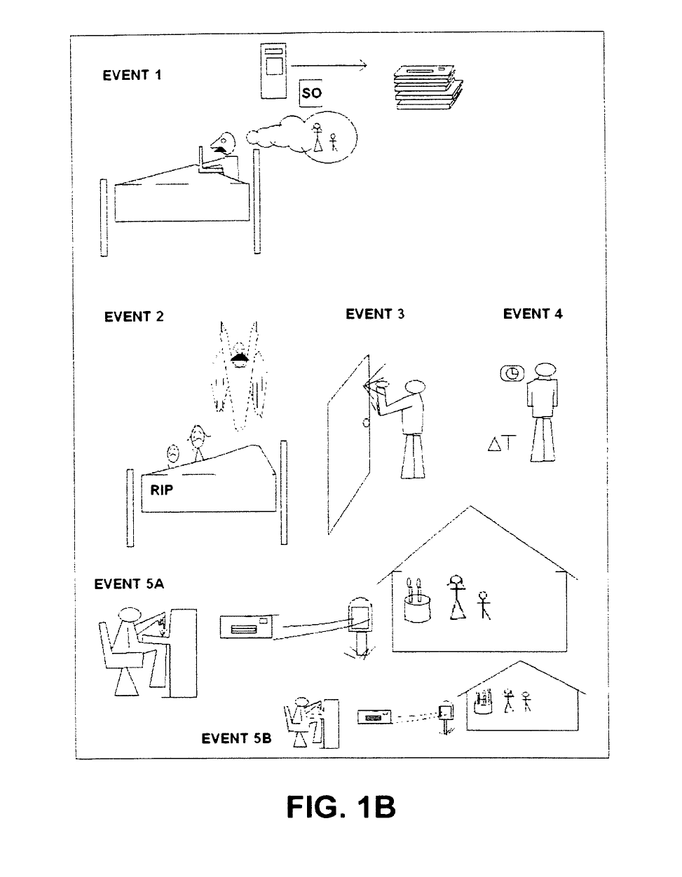

Referring now to FIGS. 1A and 1B, the method 10 of the invention includes several steps. In a first step 12, the method 10 manages the registration of a user, be it a client 14 or a recipient/beneficiary 16. In an optional second step 20, an address update routine is periodically executed. In a third step 22, at an appointed time, an activation submethod is executed. In a fourth step 24, if an activation submethod 22 outputs an initiation signal, then a service order 26 is executed at the appointed time. Documents associated with service order may include registration instructions for the recipient 16, which enables the recipient to register using the registration submethod 12.

Referring in particular to FIG. 1B, a schematic diagram shows of four basic events associated with the method 10 of the invention. In a first event 1, the user 14 registers and provides any inputs required for the execution of the service order 26. In a second event 2, the user 14 becomes incapacitated. In a third event 3, the activation submethod 22 is initiated. In a fourth event 4a and 4b, the service order 26 is executed. In this example, the service order 26 is the mailing of a birthday card, which takes place in a series of events 4a, 4b, etc, on the birthday of a recipient. Of course, the birthday card can be sent only by email, by email and post, or in any other way, according to the wishes of the incapacitated user client 14.

In an embodiment of the method 10, the method permits the administrator to prepare to invite invitees by inputting the email addresses of invitees to the memorial object webpage, by providing fields to identify the invitee by name, class (such as relation to administrator or memorial object), birthday, etc.

In another embodiment, the method 10 permits the administrator to invite the invitees to the website to pay their respects to the memorial object, based on an activation protocol, such as the non-response of the administrator to a query from the purveyor of the system on which the website is hosted and maintained.

The activation protocol optionally is followed by an introduction and acceptance protocol which binds the invitee to contractual preconditions to the execution of the service order.

In another embodiment, the method includes an update submethod to ensure that valid contact details are maintained for invitees and users of the system.

In another embodiment, the method provides the invitee with means by which he may himself post messages which are stored in association with the memorial page and which are viewable by others or a specific visitor or visitor class, optionally, after having been filtered for objectionable language, depending permissions of others.

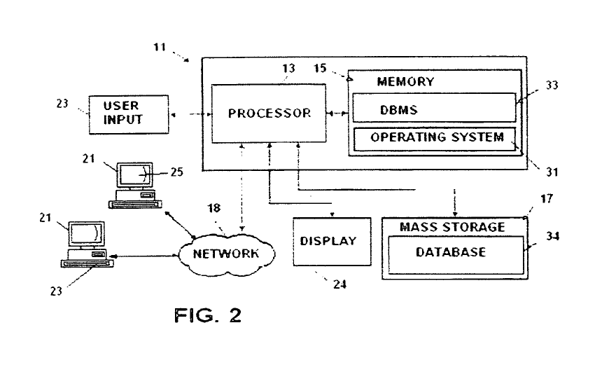

Referring now to FIG. 2, the method 10 is implemented in a hardware and software environment, on, for example, a server apparatus 11. For the purposes of the invention, apparatus 11 may be any type of computer, or computer system, including a client computer, a server computer, a portable computer, or a handheld computer, etc. Moreover, apparatus 11 may be implemented using one or more networked computers, in a cluster or other distributed computing system such as the Internet. Apparatus 11 is hereinafter referred to as a “computer”.

Apparatus 11 typically includes at least one processor 13 coupled to memory 15. Processor 13 may represent one or more processors (e.g., microprocessors), and memory 15 may represent the random access memory (RAM) devices comprising the main storage of apparatus 11, as well as any supplemental levels of memory, e.g., cache memories, non-volatile or backup memories, read-only memories, etc. In addition, memory 15 may be considered to include memory storage physically located elsewhere in apparatus 11, e.g., any cache memory in a processor 13, as well as any storage capacity used as a virtual memory, e.g., as stored on a mass storage device 17 or on another computer coupled to apparatus 11 via network 18 (e.g., a client computer 21).

The apparatus 11 also typically receives inputs and outputs for communicating information externally. For interface with a user or operator, the apparatus 11 typically includes multiple input devices 23 (e.g., a keyboard, a mouse, a trackball, a joystick, a touchpad, among others) and a display 25 (e.g., a CRT monitor, an LCD display panel, and/or a speaker, among others). Otherwise, user input may be received via another computer (e.g., a computer 21) interfaced with apparatus 11 over network 18, or via a dedicated workstation interface or the like.

For additional storage, the apparatus 11 may also include one or more mass storage devices 17, e.g., a floppy or other removable disk drive, a hard disk drive, a direct access storage device (DASD), an optical drive (e.g., a CD drive, a DVD drive, etc.), and/or a tape drive, among others. Furthermore, apparatus 11 may include an interface with one or more networks 18 (e.g., a LAN, a WAN, a wireless network, and/or the Internet, among others) to permit the communication of information with other computers coupled to the network. It should be appreciated that apparatus 11 typically includes suitable analog and/or digital interfaces between processor 13 and each of components 15, 17, 18, 23 and 25 as is well known in the art.

Apparatus 11 operates under the control of an operating system 31, and executes or otherwise relies upon various computer software applications, components, programs, objects, modules, data structures, etc. (e.g., database management system 33 and database 35, among others). Moreover, various applications, components, programs, objects, modules, etc. may also execute on one or more processors in another computer coupled to apparatus 11 via a network 18, e.g., in a distributed or client-server computing environment, whereby the processing required to implement the functions of a computer program may be allocated to multiple computers over a network.

Referring again to FIG. 1A, the submethods 12 and 24 of the method 10 can be further broken down into substeps. In the registration submethod 12, in a first substep 12a, the user 14 is registered at a first access level, and assigned a user name and password. In a second substep 12b, the method determines if the user 14 is a client desiring after incapacitation services. If no, in a step 30, the user 14 is offered ancillary services and/or products (family tree building options, books and other media on the subject of life, death, estate planning, etc). If yes, in a third substep 12c, the registration submethod 12 is executed for a client 14 anticipating incapacitation. In an optional substep 12d, the recipient/beneficiary 16 is queried as to whether he or she would like to register and if so, he is brought to the substep 12a.

In the execution substep 24, the service order 26 is executed. Optionally, where permitted by the client 14, documents associated with the service order are appended with registration information for the recipient 16.

A first level registration substep 12a of the method 10 of the invention solicits basic information, such as name and contact details, providing access to a top level of information of interest to the subscriber, which is published on a web site of the purveyors of the method 10 of the invention.

Subscription Module

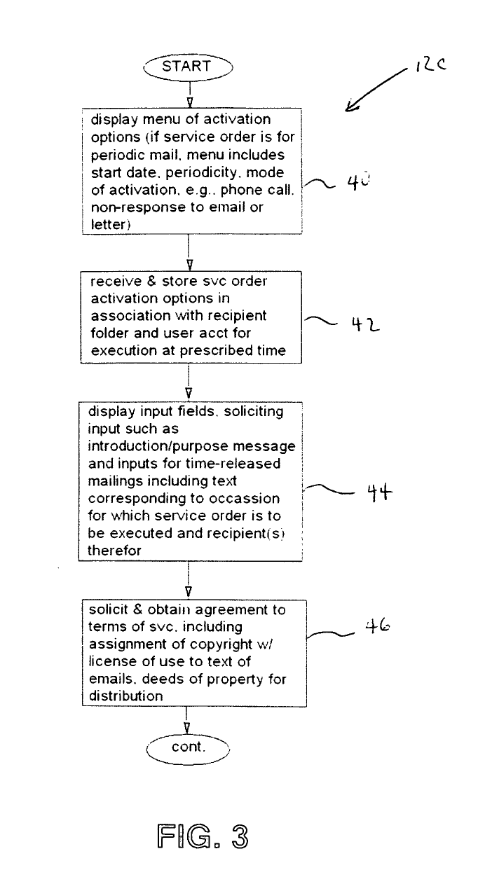

Referring now to FIG. 3, the registration submethod 12c includes a number of substeps. In a first step 40, the CGI program operating on the server 11 transmits interface data to the computer 21 to cause the computer to display a menu of activation options to the user 14. Such activation options include a selection of the type of service order 26 desired, such as periodic mail (sent by post or email, a order to deliver a product such a flowers on a certain date to a certain location, and related data such as start date, periodicity, mode of activation (e.g. via phone call, non-response to email or letter).

In a second step 42, the submethod 12c receives and stores the service order activation options in association with the user account, preferably, in a recipient folder, for execution at a prescribed time. In a third step 44, the submethod 12c causes the computer to display input fields soliciting inputs such as an introduction/purpose message (textual, audio or visual, such as via an mpeg) and the text and/or products and services to be sent/performed periodically in time-released fashion, including, for example, text corresponding to the occasion for which the service order is to be executed, and recipient(s) therefore, whether the user desires that a contact information routine be executed from time to time, etc, and receives and stores such inputs given in association with the user, preferably organized in a recipient folder. In a fourth substep 46, the server 11 causes the display of a message soliciting agreement to terms of service, such as the following:

Assignment of copyright, with license to use back to assignee for use for his life only (e.g., such right to use terminates on his death)

Emphasis on importance of keeping contact details up to date

Pledge of accuracy of information

Pledge not being used to create ill-will

Permission and order to initiate service order upon non-response to a query

Limitation of Liability and indemnification

Forum in case of dispute (e.g. Switzerland)

Click to agree

Note that the copyright assignment of rights in text of the emails which are slated for after-incapacitation delivery is necessary in the event that incapacitation is the death of the user, in order to prevent ownership in such copyright to pass to the heirs of the user 14 who will demand the return of such works before the delivery order is executed according to the will of the user 14.

In addition, the registrant may optionally be given the opportunity to select an email address, from a list of possible email address such as the following:

username@tilwemeetagain.com

username@saintlymail.com

username@mailfromabove.com

username@winkfromabove.com

username@heavensmail.com

username@heavenspost.com

username@thereafter.org

username@eternalportal.com

username@elportaletemo.com

username@etemalink.com

username @ etemamail.com

Further, for security's sake, at least two email addresses for contact as well as a postal address may be requested.

Optionally, the user is provided with tools to edit his own memorial page and to select whether or not his emails or the responses thereto, should be published on this memorial page. Useful information may also be published on this memorial page, such as the recipients favourite colors, his favourite tastes, music, and allergies as well, including any genetic or hereditary traits he or she exhibited. Of course, the user may include the cause of his death and any family health history, which may be of use to his prodigy.

When the list of service options is made, the method calculates the present value, plus margin, for the services and or related products ordered and solicits the user 14 to pay for such in advance, using, for example a credit card or e-transfer.

Activation Module

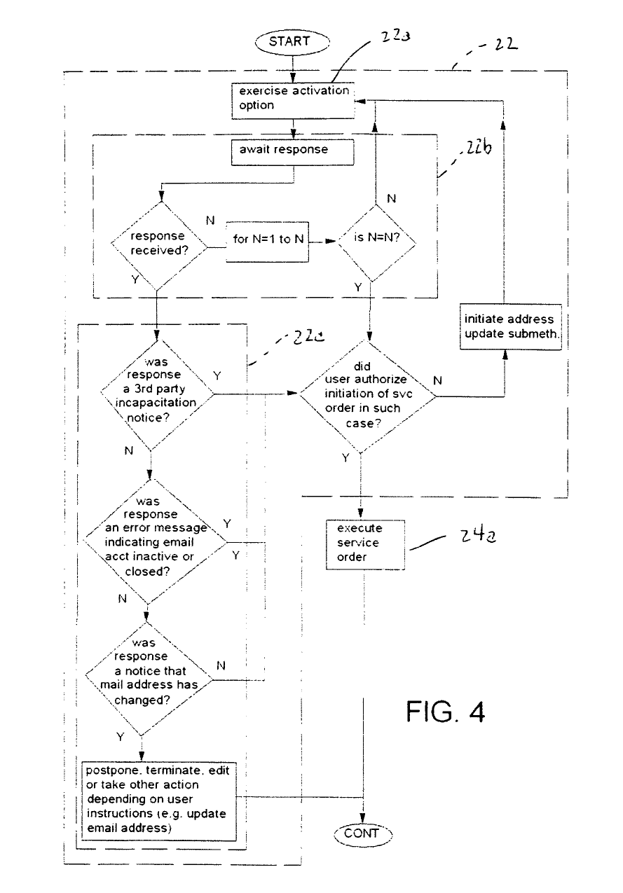

Referring now to FIG. 4, the activation submethod 22 of the invention includes several substeps. In a first substep 22a, the activation option selected by the client is exercised. In a second substep 22b, the method 10 awaits a response, and, if after a pre-determined period of time, no response is received, then the method asks again up to N times, according to the instructions received from the client. In a third substep 22c, response is analyzed, to determine whether the response was a third party incapacitation notice, an error message indicating that email account is inactive or closed, in which case, if so authorized by the client, the service order is activated. Otherwise, in a fourth substep 22d, appropriate action is taken, such as postponing, terminating, modifying service order, or correcting mail address, as instructed by the client.

Referring again to the activation options mentioned in substep 22a, this may include a telephone call and query, non-response to a letter after a predetermined amount of time, non-response to an email after a pre-determined amount of time. A telephone query may simply be asking whether the client is home and listening for the answer, which may include a requirement that a code word be given in order to authenticate the user 14, should the person responding claim to the user. Activation may also simply begin at a specified time in the future, long enough into the future that activation is assured after the death or celebrated event of the memorial object or client.

Introduction and Acceptance Module

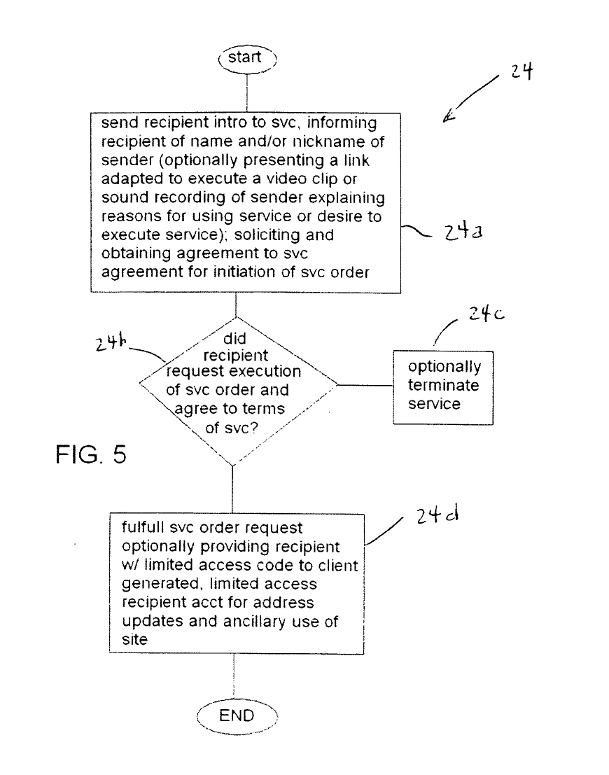

Referring now to FIG. 5, the service order execution submethod 24 includes several substeps. In a first optional substep 24a, where the client is a person who has died and who wished that certain services be performed on the behalf of a beneficiary, the recipient is sent an introduction to service and is informed of the concept of the method of the invention, in order to minimize the emotional consequences that might be associated with receiving an unexpected communication or a gift from a recently deceased loved one. Where the method of informing is an email having, for example, html or xml links, the recipient 16 is provided with a hypertext link or an icon which is activated by a mouse click to show a video and/or audio clip (in mpeg format, for example) of the client 14, explaining his intentions in using the method of the invention. In a logic gate 24b, the informational email solicits the recipient 16's agreement to terms of service for initiating the service order and, in the event the client 14 wished to communicate valuable information, such as the location of a key to a safety deposit box, then the introduction would include an authentication step in which the recipient must respond to a query which, if answered corrected, would satisfy the client 14 of the recipient 16's identity. Such an authentication step is initialized via the input by the client of keywords in association with a question he asks in a communication with the recipient, as described in more detail below.

Otherwise, in a third substep 24c, optionally, the recipient 16 is given the option of terminating the service. One reason for termination of the service could be the fact that the client is not dead and the activation of the service order by non-response failed in its assumption. If the recipient 16 did request execution of the service order, then in substep 24d, the service order request is fulfilled, optionally providing recipient 16 with a limited access user name and password to log on and modify address information stored in the recipient folder created by the client, and presents the recipient 16 with ancillary products and services that might be of interest. For example, an ASP version of family tree creation software, such as that available from

Pearl Street Software, in Boulder, Colo., may be offered to the recipient 16 to help them build their family tree. Family Tree Legends™ version 4.0 provides users with tools to communicate with other users instantly over a secure, encrypted network where users can share text messages, scrapbook images, and file data. Such software permits users to find, review, and integrate matching data in the files of other users, to back up data files, and to publish the family tree in a home page with a minimal learning curve. In addition to the services offered by the method 10 of the invention, the recipient 16 may purchase gifts, flowers, cards, and downloadable software products, as well as books and religious icons may be offered.

Mail Module

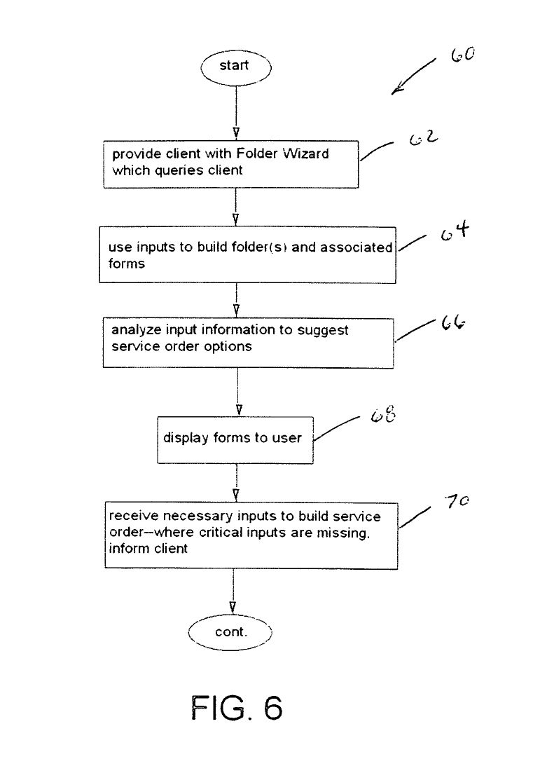

Referring now to FIG. 6, a delivery submethod 60, facilitates the editing, storage, association, and delivery of mail, such as emails and/or letters at a specified time or interval. In a first substep 62, the submethod 60 provides the client 14 with a Folder Wizard which walks the user through the creation of recipient folders and related forms, by which questions are asked of the client 14 (such as “do you have any surviving children?”, “What are their names, and ages?” “Do you have a surviving spouse?” “What is his/her name or age?”) and uses this information to create corresponding folders for each potential recipient, soliciting further information about each recipient such as their names, birthdates, wedding anniversaries, dates of death (where the service order includes delivery of flowers to a grave) addresses, and relationships to the client, as well as service order information (start date, event name, periodicity, end date). In a second substep 64, such inputs being used to generate an appropriate, pre-configured recipient folder for convenient storage of recipient contact and service order data, and for automatically associating links to features, themes, or services which are likely to be of interest according to the input relationship (if husband and wife relationship, the CGI program transmits links which facilitate the selection of a love theme and can suggest special mailings such as on the anniversary of marriage, on a wedding date, on a birthdate of a child, on mothers day, for example). Note that, in a preferred embodiment, the end date is suggested after input of the birthdate, by the system comparing the birthdate to today's date, accessing a look-up table of life expectancies, calculating how many more years the recipient is likely to live and thus, outputting a suggested end date, as well as populating a default field which, unless changed, will generate a suggested number of input fields for mail messages corresponding to the life expectancy of the recipient. Further, optionally, each input field includes a Hint generator, which periodically displays hints associated with the event on which the mail is to be sent, to help the client in editing content for the message. For example, if the event is a birthday for a 20 year old, then a set of hints which might be cycled through a hint or banner window might be as follows:

? On this day in History/Examples of world events when you were 20, include:
President Smith was elected President of the US
XYZ was the hit song playing on the charts
? What did you do on your 20^{th} birthday?
? At this age, a <female/male, as the case may be> is struggling with:
   X
   Y
   Z
? What advice would you have for someone celebrating their 20^{th} birthday?
? Would you like us to suggest a poem for your loved one?

In a third substep 66, the submethod 60 analyzes the input information to intelligently suggest, and to allow the client 14 to choose from, service order options, including such options as having flowers delivered to a specific location on a specific date, accompanied by a client-written card, for example, or the delivery of mail or post written by the client at a predetermined time at a pre-determined interval or periodicity. In a fourth substep 68, the submethod 60 presents a date-specific form created for example by a form wizard created using “INFOPATH”™ on a “SHAREPOINT SERVER”™ (the input fields being generated depending on the client's answers to queries, such as periodicity, and start and stop dates) in which the user 14 can input service order information such as event name, delivery date, message text, text framing such as in an e-card form including graphics and/or selected animation from a menu of options such as those available at www.e-cards.com or www.bluemountain.com and attachments including gift certificates or vouchers for ordering flowers or other products. For example, where the periodicity selected is annual, and the start date is 2006, end date is 2056, then the Form Wizard creates fifty text input fields which can be customized by the user with specific text and attachment of card motif selection, attachment of mpegs, etc. In a fifth substep 70, taking the client's inputs, the submethod 60 compiles the service order 26 and prepares it for execution.

In an optional service, recipients are able to send responses to the email communications. A central mail server, similar to “OUTLOOK”™, scans incoming mail using rules which look for the presence of such keywords in the response. Where such keywords exist, then the mail is marked for further action, such as the sending of a response email, such as a thank you email, or even a code or mailing of a deposit box key by employers of the purveyors of the system of the invention. For example, a pre-programmed message may be displayed on a field of the email to the recipient reads “You remember your first puppy's name? You know, the runt that couldn't sleep anywhere by next to your bed?”. The recipient then responds in a response field on the website or via a “respond to” feature of their email program and sends his perhaps detailed response, including the name of the puppy. A rule set on the, for example, Microsoft Outlook Exchange server, scans the emails coming into the client's email box, and if the keyword is detected, executes a macro or rule which automatically sends a response, which could include, for example, a bank account number and access code, or instructions on where the client may have hidden or buried a gift. Of course, such emails should not to be published. Therefore, where the client has selected an option by which all his emails and responses are published on a memorial page associated with the client, such emails having the trigger question and the answer are filtered out of those which are published.

When the delivery submethod 60 is integrated in a color printer or printing system (not shown), then, on the appointed day, the method 10 causes the system to automatically print out a card or letter with the client edited text corresponding to that particular event (birthday, for example), and a corresponding envelop addressed with the recipient address stored in the database. A convenient format for such card is a tri-fold (or a bi-fold with a third overlapping minor panel) wherein, on an outside portion of which, the recipient and return addresses can be printed, followed by printing of the associated message on the inside. Then such card can be closed via a seal or even the stamp to be used for delivery itself, and delivered by regular post. Of course, a postage meter machine can be integrated in an automated process so as to automatically posted and then placed in a post office bag for delivery in bulk by the postal service.

In another feature, the wizard offers users the opportunity to select from a variety of canned service orders, optionally suggesting the canned service order which match the client's profile (determined from a review of the client or from an automatic profile analysis of the client's profile inputs), thereby enabling users who are weak, cannot write well, or are near death and therefore have no time to fully customize their profile to prepare a fully populated service order quickly and conveniently. An evangelical message presenting, for example, the four spiritual laws, is easily integrated into such a canned service order. Optionally, one of the inputs is the user's estimated time of death so that the canned service orders can be customized in a manner enabling communication of the approximate time of death (e.g., enabling communication of a message such as “I've been gone now for X years”, or pre-edited to send out evangelical messages).

A help feature suggests the theme based on characteristics such as the relation of the recipient 16 to the client 14, or the event type of relationship. For example, if the event is a birthday, the help feature will suggest that the client 14 describe in text for posting on the memorial site or printing on a card, what happened to him on his same birthday, or to add advice to someone of the age of the recipient at the time of reception or information about a related family event. In another example, where the relationship is parental, then the help feature, next to the end date information, will suggest that the client 14 create enough cards to bridge the gap between the client's death and the expected date of death of the recipient 16. The purpose of the help feature is to facilitate the population of the data fields required to fulfil the service order 26.

Update Module

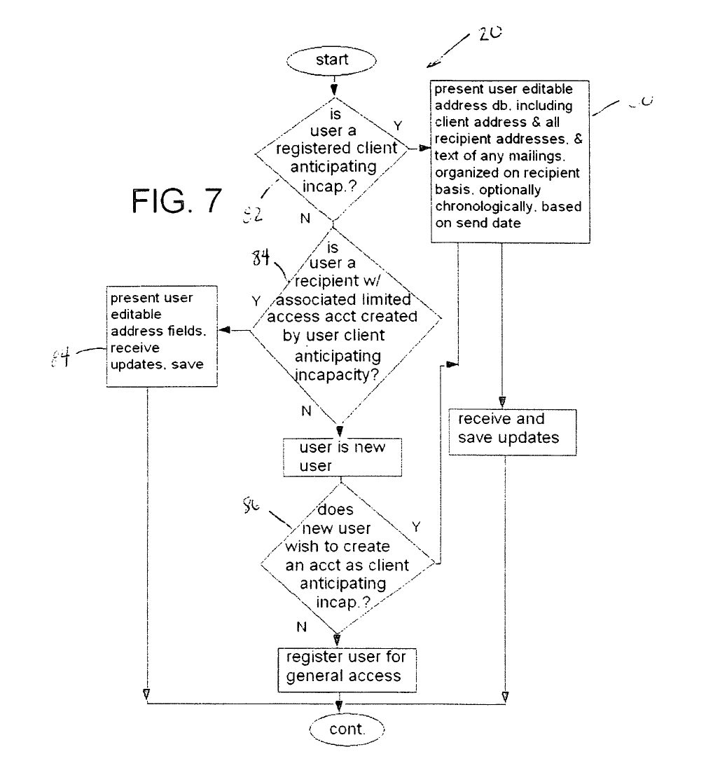

Referring now to FIG. 7, an address update submethod 20 is provided which helps ensure that the service order is timely executed and that it may continue to be executed throughout the order life. Further, such submethod 20 provides a means by which new clients may be generated or other products and services sold.

In a first substep 80, a logical or gate 82 determines if the user is a registered client 14 anticipating incapacity. If yes, the user is sent to submethod 60. If no, a second or gate 84 determines whether the user is a recipient with an associated limited access account created by the user client 14 anticipating incapacitation. If the user is a recipient 16 with associated limited access account created by the user 14, then, in substep 84, the recipient is presented with user editable address and contact information, whereby the user may review, edit and update the information and save such changes.

If no, the user is a new user, and, in substep 86, the submethod 20 asks whether the user wishes to create an account as a client anticipating incapacity. If no, the user is prompted to generally register for limited, general access as sent to substep 30 of method 10. In an example of use, a client 14 has been told by his physician that he is not likely to live more than one year. That client 14 logs on and registers on the system. The method 10 of the system asks for the names, contact information and ages of his dearest friends and relatives. This information is then used to automatically generate folders and as inputs to a form tool which associates similar services to the user client and recipient relationship, and to generate a number of input fields associated with the expected life span of the recipient, and then makes recommendations to the client user. The client user is presented with terms of service which he accepts and goes through the work flows described herein. In an alternate embodiment, the mailing may be initiated at a date long enough in the future to best guarantee that the client is dead and that the mailing will now be timely. To overcome

Further, when a invitee receives his introduction email, he also receives a password and user name, allowing him to logon to the server. There, he can view those memorials he has a right to view, but now the client has set things up so that the “epitaph” is customized to that particular invitee, and potentially, to the day, season, age of invitee. . . . A standard time dependent message might be:
Epitaph: “It's Jul. 1st, 1943—my birthday. I would be years old if still alive today. My ______ (daughter/son) is now ______ years old. To all who visit me on this day, I wish to say ______.”
   A visitor dependent message might be:
Epitaph: “John Doe, who only wanted the best for his daughter, Amy, on whom he wishes only the best life can offer.” Message to visitor: Amy, I love you and hope that you still think about me from time to time. You're now 73 years old. Use the time you have left wisely. Hebrews 12:1.
   The user is simply provided with input fields when a invitee folder is configured. In addition, input fields are provided for epitaphs that are time dependent, such as as follows:
Generic Epitaph 2010, enter text: [ ]
Generic Epitaph 2020, enter text: [ ]
Invitee Specific Epitaphs:

Invitee: ______, Year or validity dates (select from calendar or enter beginning and end dates): ______ Text: ______

Optionally, the client is provided with the ability create a “private (for selected recepients)” or “public” memorial. For example, a public memorial might include general info of potential interest to any visitor, such as favorite colors, foods, words of wisdom, favorite jokes, and wishes for posterity. The private memorial would include topics such as regrets, secrets revealed (password protected), most embarrassing moments, etc. However, a half-public option may also be provided (where only certain health information is published and others available only to specific visitors).

In another embodiment, the memorial site provides visitors with the option of purchasing a “virtual flower”, a digital picture of a flower, optionally animated. When a flower is purchased, the purchaser is recognized via a listing of donors on the memorial site.

Optionally, site users are provided with the ability to create a memorial page to honor some one else.

In another option, each memorial page can be purchased or rented on a time basis (i.e., for a contractual period of time), whose active life can be extended by others purchasing more time. If no one visits a particular memorial page a certain period of time, then it's posting life is limited to say 5 years. If someone visits, then, with each visit, the life of the site is extended by x minutes, hours or days. On the page, a counter may indicate the number of visits and indicate as well, the current expiration date for the site. Visitors can purchase more time and watch the expiration date change to the extended date.

This, together with the fact that the site is dynamic, better ensuring future re-visits of the invitees. More visits increases the likelihood that the invited will keep his contact details updated so as not to lose contact in the future.

In an alternate embodiment, the invitation may be initiated at a date long enough in the future to best guarantee that the client is dead and that the invitation will now be timely. In another means of helping to ensure that the contact details are still valid, the client is provided with the option of offering a pre-paid service to the recipient, such as pre-paid email address, emailing and storage for, say, ten years. Via the service agreement which the recipient must accept for this service, the recipient agrees to allow the service provider to communicate with the purveyors of the method of the invention, to update the mailing and emailing address of recipient. In this way, the purveyors are better ensured of having the correct address at the time of execution of the service order.

In another alternate embodiment, the mailing may be initiated at death by an undertaker as part of a death package that the client may purchase from the undertaker. In this alternate embodiment, the user is given a logon username and password. The user then logs on and answers the queries as described above, allowing the system to create appropriate folders and text fields so as to allow the user to complete the text and complete the service order. Thus, in this embodiment, the initiation of the service order upon non-response to a query is not required. The service order is initiated by the client's loved ones by their informing the undertaker to execute the service order.

In an alternate embodiment, the system outputs and prints all cards in advance and mails them to the client for personal signature. Such cards are then returned by the client and stored for delivery at the appropriate time.

In an alternate embodiment, the client chooses the typestyle for a printable stylized signature from a database of signature styles and the cards are printed with this signature.

In another alternate embodiment, the client chooses a listing of signature styles and gives permission to the purveyors of the system, in the service order agreement, to sign on behalf of the client, trying to follow the style of the pre-selected signature style.

In another embodiment, in the subscription step, the client is queries as to whether or not he would like emails he sends, or his variable messages and any answers thereto, published on his memorial page. In order to minimize the inadvertent publication of writings considered too personal for publication, the recipient is warned, in a header or a footer of the email of the recipient of the possibility of publication. Thus if the recipient responds, he implies his permission for publication of such response. The recipients may also optionally be given the ability to log on to the memorial site and delete any emails from them that were inadvertently published. In another embodiment, the client is provided with input means for the name of an executor, someone who is charged with activation of the service order as well as provided with other permissions according to the desire of the client, including editing the memorial, updating recipient email addresses, and general memorial maintenance (including ordering additional services to enhance the features of the memorial). The executor may be a caregiver, relative, legal executor, etc. On a first level, the executor, via a client-selection, is given only permission and access to activate or disactivate the service order. On other more trusted levels, the executor is permitted by the client to do the other things, including, potentially, writing the new mail for distribution to the recipient mailing list of the client. Some edits are important particularly where the client dies before knowing the names of grandchildren. Placeholder names like Grandchild3 and Grandchild4, can be updated by the executor with the real names and genders of the grandchildren as they are born.

In a feature of the invention, an activation submethod actives the method upon non-response of the client to a query or series of queries.

Such a system is advantageously used by a very busy client, or a client anticipating incapacitation, namely, those who are aging and anticipate serious nursing care, death, or inaccessibility to conventional communications mediums to pre-order a service order for delivery to a prescribed beneficiary and such delivered at pre-specified dates.

In another feature of the invention, the system is used to deliver a new genre of greeting cards appropriate for after-death communication, and with the purpose of encouraging the recipient during the life of the recipient. For example, the return address in the card may include the phrase “from Heaven” (sent by email or post). Further, the user may be provided with a means to personalize the cards by inputting the face of the client in input his face and insert it in a blank face field, of a, say, skier, sking the clouds, with a message, “Powder, year round!—Postcard from Heaven”, or an angel with the face of the client pasted in, or the client, dressed in white, with two very attractive angels next to him. This could be fun too!

In another advantage, a method is provided to help deal with an age-old, as yet, unsolved problem, of providing peace of mind to those facing the inevitable and stressful event of death.

Multiple variations and modifications are possible in the embodiments of the invention described here. Although certain illustrative embodiments of the invention have been shown and described here, a wide range of modifications, changes, and substitutions is contemplated in the foregoing disclosure. In some instances, some features of the present invention may be employed without a corresponding use of the other features. It should be noted that the use of the terms “messages” or “emails” can be replaced with the terms customized or selected “post cards”, “greeting cards” and that these may be “server-based” appearing in the form of an electronic memorial, wherein for example, the message is an epitaph on the memorial, as is the case in the related applications incorporated by reference. Accordingly, it is appropriate that the foregoing description be construed broadly and understood as being given by way of illustration and example only, the spirit and scope of the invention being limited only by the appended claims.

What is claimed is:

1. An automated method operating on a computer and encoded on a computer-readable medium, the method following a logic flow that executes a service order on behalf of a client, the service order being organized by the client according to the characteristics of each of at least one class of beneficiary and wherein permission for initiation of such service order is considered as having been granted by client non-response to a query offering the opportunity of modification of such order.

2. The method of claim 1, wherein modification includes cancellation of such order.

3. The method of claim 1, wherein the query is an email query structured to solicit a response from the client and presenting a coded dialog by which the client can conveniently login to an associated account by activating an encoded object presented in the email.

4. The method of claim 1, wherein the query is structured to solicit a response from the client where the client is alive or lucid and able to respond.

5. The method of claim 1, wherein the class of beneficiary corresponds to one specific, individual, known beneficiary.

6. The method of claim 1, wherein the class of beneficiary corresponds to a contact of a political branch of government.

7. The method of claim 1, wherein, optionally, prior to execution of the service order, the beneficiary is requested to indicate his approval of such execution.

8. The method of claim 1, wherein the service order is delivery of pre-written messages each message being editable and storable for delivery at a pre-defined time to the at least one class of beneficiary/recipients, the system comprising:
(a) means for presenting and soliciting agreement by the class of beneficiary/recipients to a service agreement;
(b) message storage means, wherein the user may store tagged messages for delivery according to a desired delivery schedule;
(c) activation means wherein, non-response of the user to a query executes the delivery sequence;
(d) optional means for obtaining beneficiary/recipient consent to said delivery; and
(e) message delivery means wherein tagged messages are delivered according to the prescribed delivery schedule.

9. The method of claim 8, wherein the query is a periodic query.

10. A method of calculating a number of service order tasks to be executed after a client's death, the method comprising the steps of (a) querying the client of the age of the recipient, (b) optionally asking the client what his honest estimation of the life expectancy of the recipient, (c) upon input of the age, using this information as abscissa or ordinate information in a look up table of life expectancies to estimate the recipient's life expectancy and (d) optionally modifying this table value with any estimated value obtained from the client, and (e) outputting an estimated life expectancy, such information being used as inputs to a form wizard which creates a corresponding number of email message forms fields to be filled out by the client corresponding to messages to be sent to the recipient over this interval.
